(19) United States
(12) Patent Application Publication
(10) Pub. No.: US 2001/0012359 A1
(43) Pub. Date: Aug. 9, 2001

(54) Combination

(75) Inventors: Ralf Gester, Dusseldorf (DE); Markus Thrien, Gelsenkirchen (DE)

Correspondence Address: Clarence A. Green, PERMAN & GREEN, LLP, 425 Post Road, Fairfield, CT, 06430, US

(73) Assignee: Nokia Mobile Phones Ltd.

(21) Appl. No.: 09/749,355

(22) Filed: Dec. 27, 2000

(30) Foreign Application Priority Data
Dec. 28, 1999 (DE) 19963380.0

(51) Int. Cl. H04M 1/00

(52) U.S. Cl. 379/454

(57) ABSTRACT

The invention relates to the interim holding of telephones 10, especially with the design of a locking device that not only allows for easy separation of the telephone 10 from the holder 11 but that also provides a simple way to join these components at the same time.

To this end it is specified that there is an operable device 23, 24 located inside the telephone 10 than can be operated from outside the telephone 10 that in one of its positions secures the telephone 10 on the holder 11 and in its other position allows the telephone 10 to be separated from holder 11. This guarantees that large holders 11, i.e. holders 11 that extend beyond the clearance of the telephone 10, are superfluous. In particular, the grasping motion used to grab the telephone 10 and operate the operable device 23, 24 to separate the telephone 10 from the holder 11 must be viewed as a natural, integrated motion due to the design of a device 23, 24 that is operable from outside the telephone 10 but that is otherwise located inside the telephone 10 itself.

### FIELD OF THE INVENTION

The invention relates to the interim holding of telephones, especially with the design of a locking device, that not only allows for easy separation of the telephone from the holder but that also provides a simple way of joining these components at the same time.

### SUMMARY OF THE INVENTION

According to the background of the invention it is known that mobile telephones or cordless telephones are joined to a holder for safekeeping or to load the battery pack. To fulfill this purpose, holders are generally equipped with a cavity in which the corresponding telephone is placed for safekeeping or to load it. If the corresponding telephone is operated as a car telephone, for example, additional safety measure are required to prevent a car telephone in the holder from being thrown out of the holder during an accident and possibly injuring passengers. Examples of known safety measure are snap-hook connections that snap into place behind corresponding tabs when the telephone is joined to the holder. Due to the fact that car telephones are often commercial mobile telephones and therefore do not have any special features in spite of the ability to use them in the vehicle, the securing mechanism that holds the mobile telephone in place in or on the holder is only formed on or inside the holder. Refer to DE-A-1 99 34 099 for examples of such mechanisms.

As can easily be realized, the integration of the corresponding securing mechanisms on or in the holders results in a requirement for more space for the holders that exceeds the clearance provided for the mobile telephones, which increasingly leads to problems in the automobile industry as the purchaser of such holders.

For this reason the invention is the result of the task of specifying a holder for telephones that guarantees a “crash-safe” connection between the holder and telephone that does not require more space than the space provided by the clearance of the corresponding telephone. It is also the task of the invention to ensure that the unit is easy to operate and is adapted to the natural grasping motion required to separate the telephone from the holder and place the telephone in the holder.

### SUMMARY OF THE INVENTION

This task will be accomplished using the features specified in claim 1. Advantageous extensions and expansions of the invention can be obtained in claims 2 through 9.

If there is an operable device located inside the telephone than can be operated from outside the telephone and that in one of its positions secures the telephone on the holder 11 and in its other position allows the telephone to be separated from holder, then it is guaranteed that large holders, i.e. holders that extend beyond the clearance of the telephone, are superfluous. In particular, the grasping motion used to grab the telephone 10 and operate the operable device 23, 24 to separate the telephone 10 from the holder 11 must be viewed as a natural, integrated motion through the design of a device 23, 24 that is operable from outside the telephone 10 but that is otherwise located inside the telephone 10 itself.

Edges that can cause injury are avoided when the combination is designed in accordance with claim 2 and the panel placed in the complementary cavity to hold the telephone is formed on the telephone itself. This does not mean, however, that the panel must always be joined to the telephone. On the contrary, the panel can also be formed on the holder. If the latter is implemented, then a complete redesign of the telephone itself is avoided.

An especially simple and safe connection is the result when the configuration comprising the telephone and holder is designed in accordance with claim 3. When the knuckle is formed on the edge that is closer to the center of the earth when the telephone and holder are joined, then it is ensured that the telephone will still be held by this edge when the telephone is separated from the holder so that the telephone will not fall to the ground. If in accordance with claim 4 there are locking hooks on the edge that are in direct spatial relationship to the operable device, then an especially simple connection and separation process for the telephone and holder is the result. If the holder or panel has flat sections, of which at least one flat section is equipped with a latch, the modification of the telephone is limited to the creation of recesses in the telephone when the telephone is joined to the holder.

The contact of the telephone with the other components used for communication is then especially simple when in accordance with claim 7 there are electrical contacts on the holder and on the telephone that are complementary to each other and come into physical contact with each other when the telephone is placed in the holder.

The result of a design according to claim 8 is that at least the contacts on the telephone can easily be covered to prevent physical contact with the electrical contacts.

If the operable device is designed as a slider with a handle, then there are no problems when integrating it into the telephone due to the small amount of space required for it.

### BRIEF DESCRIPTION OF THE DRAWINGS

The following figures contain the following:

FIG. 1 and 1a Each contains a combination of a telephone and holder;

FIG. 2 A locking mechanism;

FIG. 3 Another design according to FIG. 1;

FIG. 4 A cross-section AA according to FIG. 5;

FIG. 5 A rear view of a telephone;

FIG. 6 Another design according to FIG. 1;

FIG. 7a and 7b Each is a cross-section;

FIG. 8 A cross-section CC according to FIG. 9;

FIG. 9 Another design according to FIG. 5;

FIG. 10 A cross-section through a locking mechanism;

FIG. 11a and 11b Each is a phantom view of a disk according to FIG. 9;

FIG. 12a and 12b Two diagrams of another combination according to FIG. 1; and

FIG. 13 Yet another unit according to FIG. 1.

### DETAILED DESCRIPTION OF THE PREFERRED EMBODIMENTS OF THE INVENTION

The invention will now be explained in more detail based on the figures.

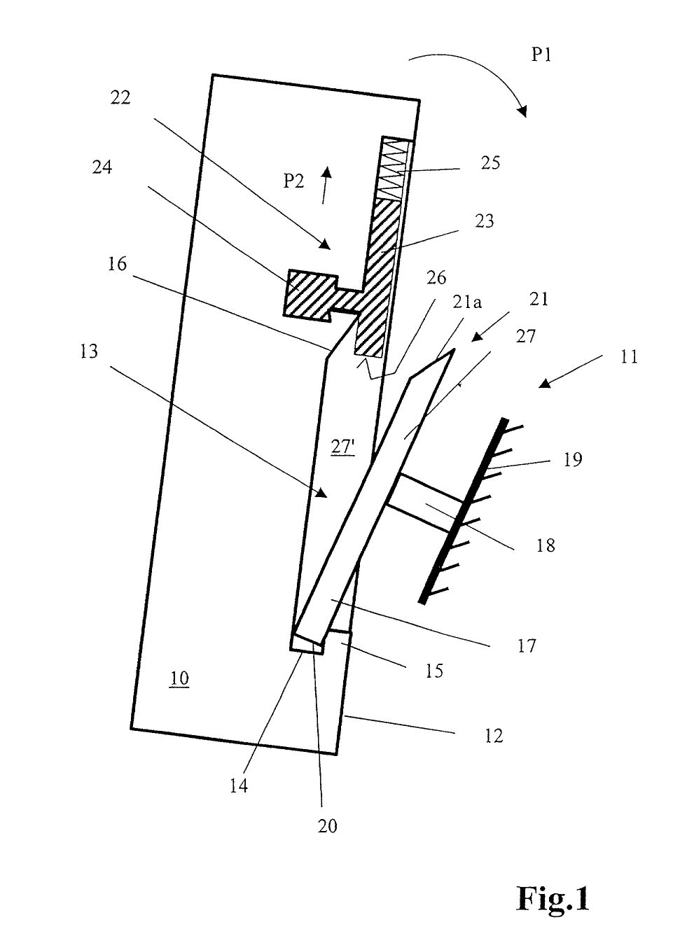

FIG. 1 shows a side view of a telephone 10 and a holder 11. There is a cavity 13 formed on the back 12 of the telephone 10, on the first edge 14 of which there is a knuckle 15. The second edge 16 of the cavity 13 is located at a distance of the length the cavity 13 from the first edge 14. As can clearly be seen in the diagram FIG. 1, the second edge 16 is not parallel to the first edge 14, but is at an angle to it of approximately 45°.

The holder 11 is formed essentially by a panel 17 and a stem 18 that is mounted on a wall 19 in the example presented. The panel 17 is formed to be complementary to the cavity 13 and therefore also has a first and second edge 20, 21.

In addition there is an operable device 22 inside the telephone that is shaded with hatches in the diagram to improve the illustration. This device 22 is formed essentially by a slider 23, a handle 24 connected to the slider 23 and a spring 25. If the slider 23 is in its rest position as shown in FIG. 1, then its lower end 26 extends into the cavity 13. If the telephone 10 is now to be joined to the holder 11, it is necessary to bring the first edge 20 of the panel 17 into contact with the first edge 14 the cavity 13. If contact between the first edges 14, 20 is established as shown in FIG. 1, then the telephone only needs to be pressed using a swiveling motion in the direction of the arrow P1 against the holder 11 to establish the final connection between the telephone 10 and holder 11. If during this swiveling motion the second edge 21 or bevel 21a of the panel 17 makes physical contact with the lower end 26 of the slider 23, then the spring 25 is compressed. If the panel 17 has reached its end position in the cavity 13 so that the two second edges 16, 21 are in physical contact with each other, then the slider 23 is moved in the opposite direction of the arrow P2 by the spring 25 back to the position shown in FIG. 1, thereby blocking any movement of the telephone 10 the opposite direction of the arrow P1.

Just for the sake of completeness we would like to point out that when the telephone 10 and holder 11 are joined, any movement of the telephone 10 perpendicular to the plane of the paper in FIG. 1 is also blocked. This is realized in the example presented in that when joined, the two side surfaces 27 of the panel 17 rest between two housing surfaces 27′, although only the front housing surface 27′ is shown in FIG. 1 to improve the clarity of the diagram.

If the telephone 10 is to be removed from the holder 11, the handle 24, which can be operated from outside of the telephone 10, must be moved in the direction of the arrow P2. This movement also simultaneously moves the slider 23 in the direction of the arrow P2, thereby compressing the spring 25 and allowing the lower end 26 of the slider 23 to free the panel 17. Now the telephone 10 can be swung away from the holder 11 and removed from it with a swiveling motion in the opposite direction of the arrow P1. If the handle 24 is then releases, the spring 25 returns the slider 23 back to its starting position as shown in FIG. 1.

FIG. 1a shows a configuration that essentially corresponds to the configuration shown in FIG. 1. In contrast to the design according to FIG. 1, the edge 21 in FIG. 1a is equipped with another bevel 21b. This bevel 21b, located on the side of the panel 17 facing the stem 11, also has the task of releasing the telephone 10 joined to the holder 11 when the handle 24 is not used and a force is applied in the opposite direction of the arrow P1. Due to the fact that in this case the bevel 21b moves the slider 23 in the direction of the arrow P2, damage is prevented that may arise when someone without any knowledge of the configuration makes an attempt to remove the telephone 10 from the holder 11. It can also be seen in the diagram shown in FIG. 1a that the bevel 21b is steeper than the bevel 21a. The less steep bevel 21a ensures that only a small amount of force must be applied to join the telephone 10 and holder 11 while carrying out the swiveling motion in the direction of the arrow P1, while the steeper bevel 21b guarantees that not every vibration or every accidental nudge will directly result in the separation of the telephone 10 from the holder 11 although it is possible to separate the telephone 10 from the holder 11 in the manner described above.

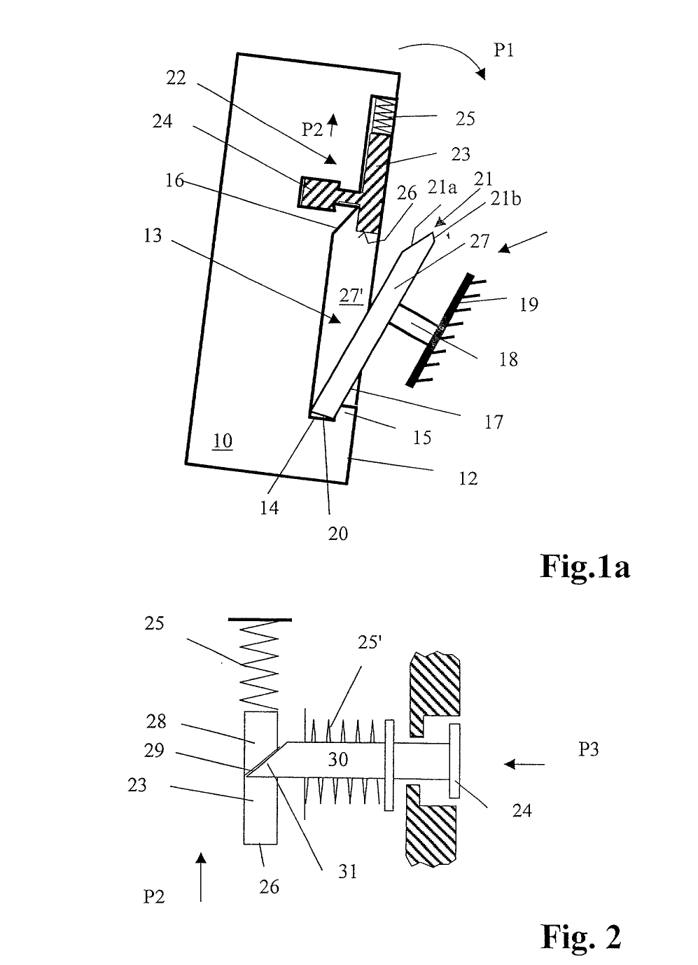

If the sliding motion (P2) of the handle 24 as shown in FIG. 1 and 1a is to be avoided and replaced by a simple pushing motion, then the modifications shown in FIG. 2 are required. This design also contains a slider 23 on which one end of a spring 25 acts and whose lower end 26 extends into the cavity 13 of the telephone 10 when in its rest position (the latter is not shown in FIG. 2). In contrast to the design shown in FIG. 1, the design shown in FIG. 2 has a projecting part 28 with a beveled edge 29 on the slider 23. The handle 24 is connected to a bar 30 that is also equipped with a beveled edge 31 on the end opposite from the end with the handle 24. If a configuration as shown in FIG. 2 is to be used as a locking mechanism in a telephone 10 according to FIG. 1, then the bar 30 and the slider 23 move perpendicular to each other and the two beveled edges 29, 31 are seated against each other. If the telephone 10 is placed in the holder 11 as described in the context of FIG. 1, then for a locking mechanism such as the one shown in FIG. 2 the lower end 26 of the slider 23 is also moved in the direction of the arrow P2 (FIG. 2) and the spring 25 is also compressed when the lower end 26 of the slider 23 comes into physical contact with the second edge 21 of the panel 17 (not shown in FIG. 2). Due to the movement in the direction of the arrow P2, the beveled edge 29 of the slider 23 moves slightly away from the beveled edge 31 of the bar 31 and then comes back into physical contact with it when the panel 17 has reached its end position in the cavity 13, and the slider 23 is returned to its starting position by the spring 25 by a movement in the opposite direction of the arrow P2. If a telephone 10 placed in the holder 11 in this manner is now to be removed from the holder 11 again, the handle 24 only needs to be moved in the direction of the arrow P3 by pressing on it with a finger, for example. This movement causes the slider 23 to be moved in the direction of the arrow P2 by the beveled edge 31 of the bar 30 due to its physical contact with the beveled edge 29 of the slider 23, thereby releasing the panel 17 resting in the cavity 13 of the telephone 10. If the telephone 10 is then removed from the holder 11 through a movement in the opposite direction of the arrow P1 as described in the context of FIG. 1 and no more force acts on the handle 24, then the slider 23 is pushed back by the spring 25 to its starting position as shown in FIG. 2 and the bar 31 is moved in the opposite direction of the arrow P3 due to the physical contact of the two beveled edges 29, 31.

Just for the sake of completeness we would like to point out that the other spring 25′ shown in FIG. 2 that wraps around the bar 30 only aids the spring 25 in pushing back the bar 30 in the opposite direction of the arrow P3 and can also be entirely left out in another example (not shown).

The example shown in the context of FIG. 3 differs from the examples shown in FIGS. 1 and 2 only in that the telephone 10 is equipped with a panel 17 on its back 12 and the holder 11 is formed only by a cavity 13 in a wall 19 that is complementary to the panel 17. This design ensures that there are no hazardous parts, etc., protruding when the holder 11 and telephone 10 are separated. The first edge 14 of the cavity 13 as well as the second edge 16 is equipped with a knuckle 15, where both knuckles 15 extend into the open cross-section of the cavity 13. The first edge 20 on the panel 17 located on the telephone 10 is also equipped with a knuckle 15. The lower end 26 of the slider 23 equipped with a bevel 32 is formed on the second edge 21 of the panel 17. If the telephone 10 is connected to the wall 19 as shown in FIG. 3, the panel 17 extends into the cavity 13 and the knuckles 15 of the first edges 14, 20 of the cavity 13 and panel 17 engage each other, and the lower end 26 of the slider 23 snaps into place behind the knuckle 15 of the second edge 16 of the cavity 13. If, based on FIG. 3, the telephone 10 is to be removed from the wall 19, the handle 24 connected to the slider 23 only has to be moved in the direction of the arrow P2 (FIG. 3), as a result of which the lower end 26 of the slider 23 leaves the space 33 formed between the knuckle 15 on the second edge 16 and the wall 19. If the lower end 26 of the slider 23 has left the space 33, the telephone 10 can be moved away from the wall 19 by a swiveling motion P4 and then completely removed from the wall 19 by a movement in the direction of the arrow P5. The telephone 10 is joined to the wall 19 in that the knuckle 15 on the first edge 20 of the panel 17 is first brought into physical contact with the first edge 14 in the cavity 13, and then the telephone 10 is pressed against the wall 19 with a swiveling motion in the opposite direction of the arrow P4. When the knuckle 15 on the second edge 16 of the cavity 13 comes in physical contact with the bevel 32 of the lower end 26 of the slider 23 during this swiveling motion in the opposite direction of the arrow P4, then, as already described in the context of FIG. 1, the slider 23 is moved together with the handle 24 in the direction of the arrow P2. When the swiveling motion in the opposite direction of the arrow P4 has been completed, the lower end 26 of the slider 23 is pressed into the space 33 because a spring (not shown in FIG. 3) was also compressed in this example by the movement of the slider 23 in the direction of the arrow P2.

Just for the sake of completeness we would like to point out that the locking mechanism shown in FIG. 2 can also be used in an example according to FIG. 3 when it is desired that a simple pressing motion is to be used to separate the telephone 10 from the holder 11.

An example will now be explained in the context of FIGS. 3, 4 and 5 in which the movable device 22 does not act on one of the second edges 16, 21, but on at least one side surface 27 of the panel 17 instead.

FIG. 5 shows the back 12 of a telephone 10 that is not joined to a holder 11. The cavity 13 created in the back 12 of the telephone 10 can clearly be seen in this diagram. The dashed lines in FIG. 5 indicate that the slider 23 slides inside the telephone 10 for the most part and only its lower end 26 is visible.

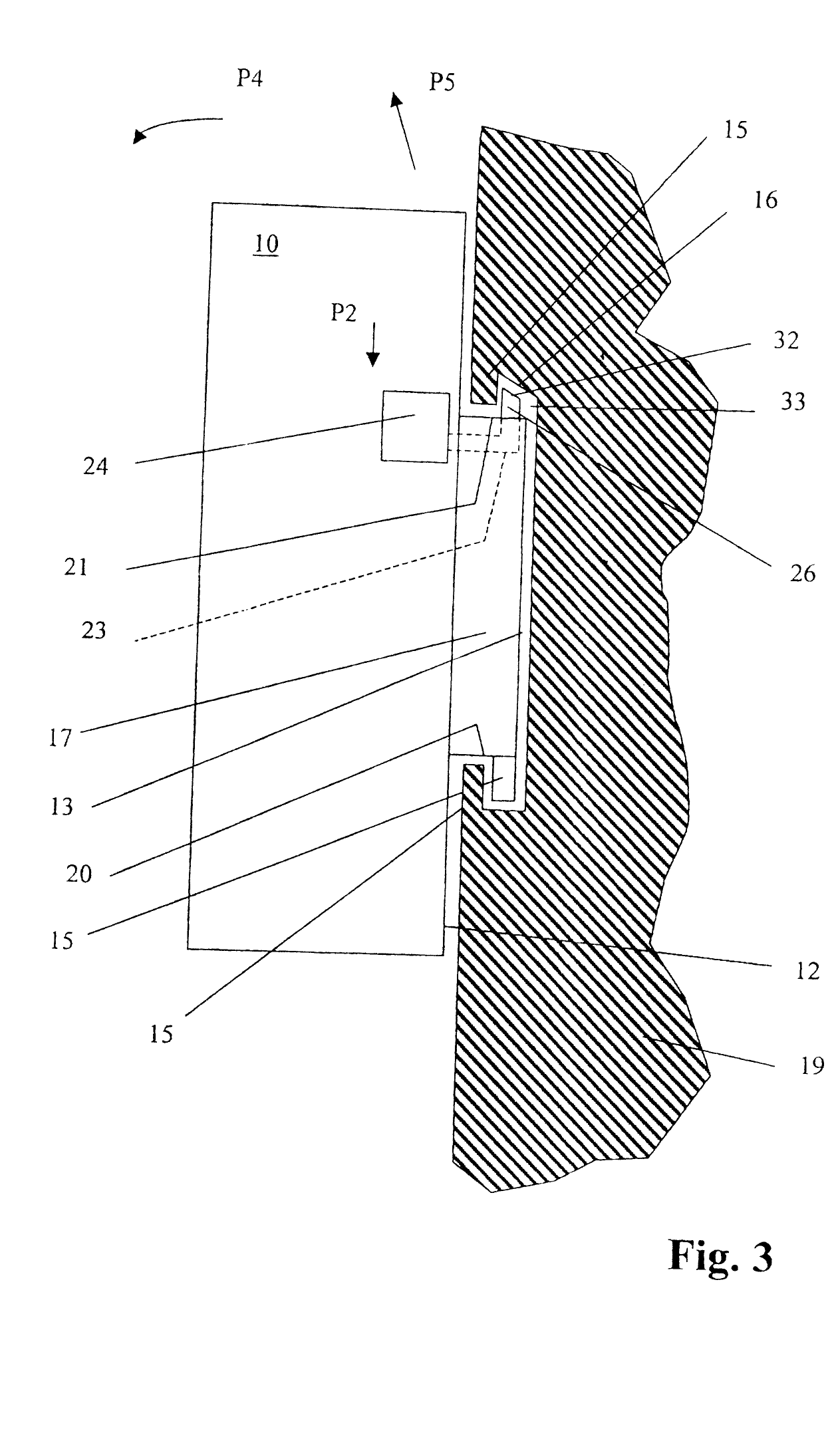

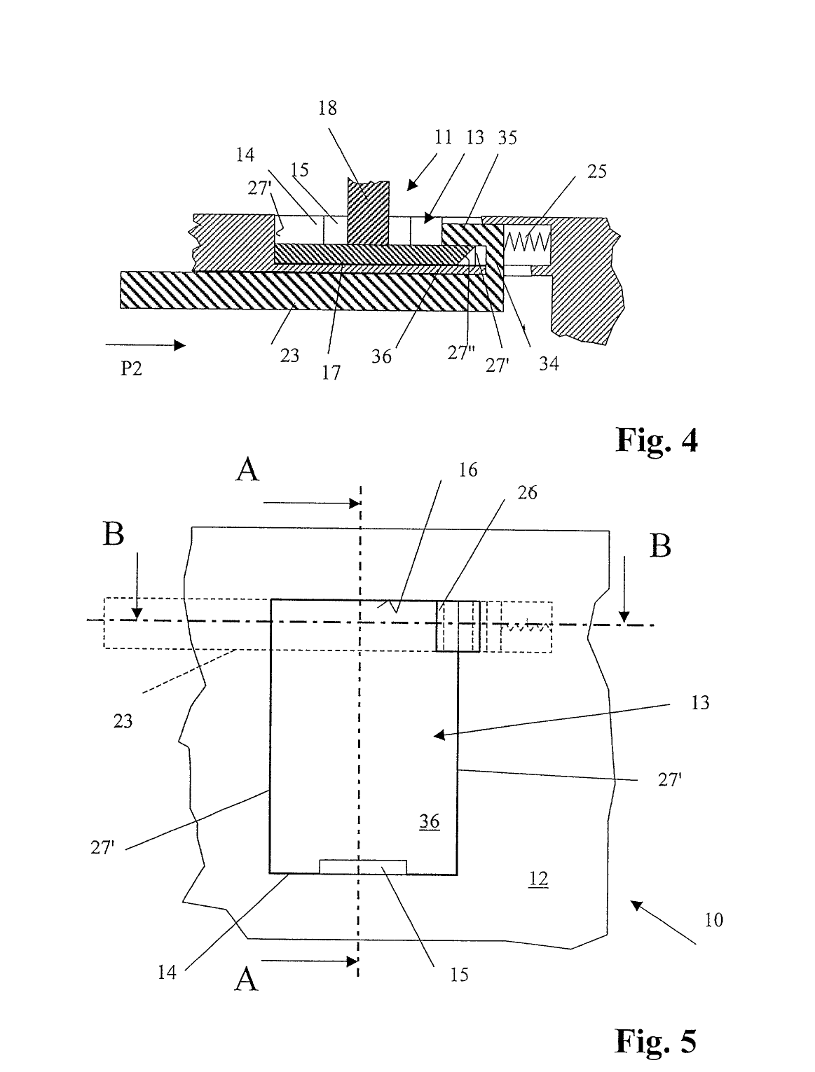

More details of this can be found in FIG. 4, which shows a cross-section BB according to FIG. 5. The slider 23, which has a rectangular cross-section in FIG. 4 and slides inside the telephone 10, has a stem 34 on its lower end 26 that is perpendicular to the long side of the slider 23 and a leg 35 on the stem 34 that is parallel to the slider 23. There is a spring 25 located between the stem 34 and the wall 19, which is part of the housing of the telephone 10 in this example. The panel 17 connected to the stem 18 of a holder 11 is inserted in the cavity 13, which is formed by the base plate 36, two housing surfaces 27′ and a first and second edge 14, 16, while the first edge 20 of the panel 17 extends into the space between the knuckle 15 located on the first edge 14 of the cavity 13 and the base plate 36. In this connected state the side surfaces 27 of the panel 17 are seated against the housing surfaces 27′. Even if this cannot be seen in FIG. 3, we would like to point out that in this state the first edge 20 of the panel 17 is seated against the first edge 14 of the cavity 13 and the second edge 21 of the panel 17 is seated against the second edge 16 of the cavity 13 to prevent any movement of the panel 17 in the cavity 13.

As FIG. 4 shows a cross-section BB according to FIG. 5, it becomes clear that the part of the side surface 27 of the panel 17 that is located between the leg 35 and the base plate 36 is equipped with a bevel 27″.

If the telephone 10 is to be placed in the holder 11, the first edge 20 of the panel 17 must first be brought into physical contact with the first edge 14 of the cavity 13 as shown in FIG. 1. The final connection between the telephone 10 and holder 11 is established in that, based on the position shown in FIG. 1, the telephone 10 is pressed in the direction of the arrow P1 against the holder 11 using a swiveling motion. If the bevel 27″ comes into contact with the leg 35 during this swiveling motion in the direction of the arrow P1 (FIG. 6), then the leg 35, and with it the slider 23, are moved in the direction of the arrow P2, which also compresses the spring 25 at the same time. If the movement in the direction of the arrow P1 is completed and the panel 17 is seated against the base plate 36 as shown in FIG. 4, the slider 23 is moved together with the leg 35 in the opposite direction of the arrow P2 due to the expansion of the spring 25, causing the leg 35 to be pushed over the panel 17 and locking the panel 17 in the cavity 13.

If the telephone 10 is to be removed from holder 11 again, the slider 23 only has to be moved in the direction of the arrow P2 as such a movement moves the leg 36 away from the panel 17, which also allows the swiveling motion in the opposite direction of the arrow P1 (FIG. 6) to be performed at the same time.

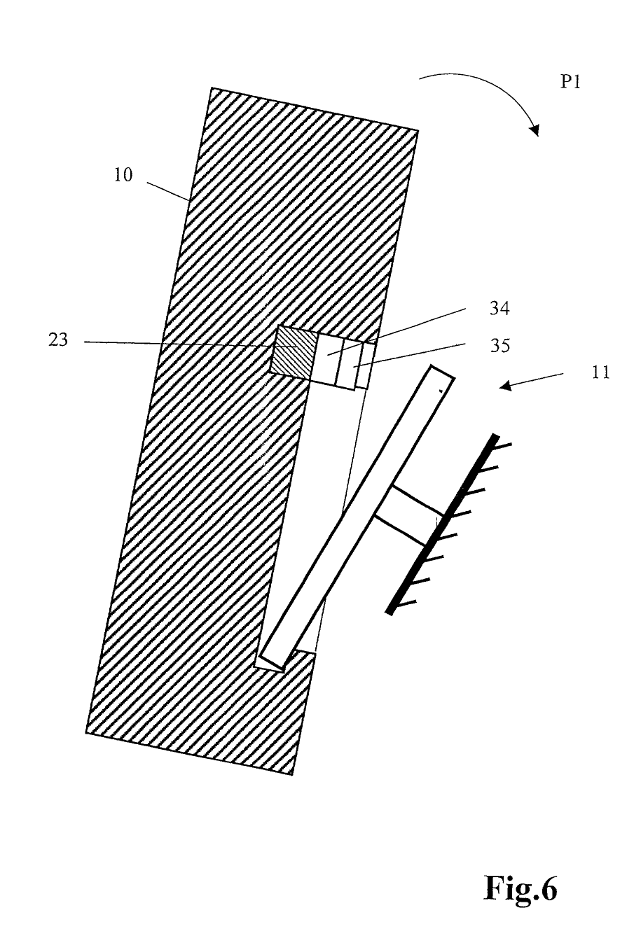

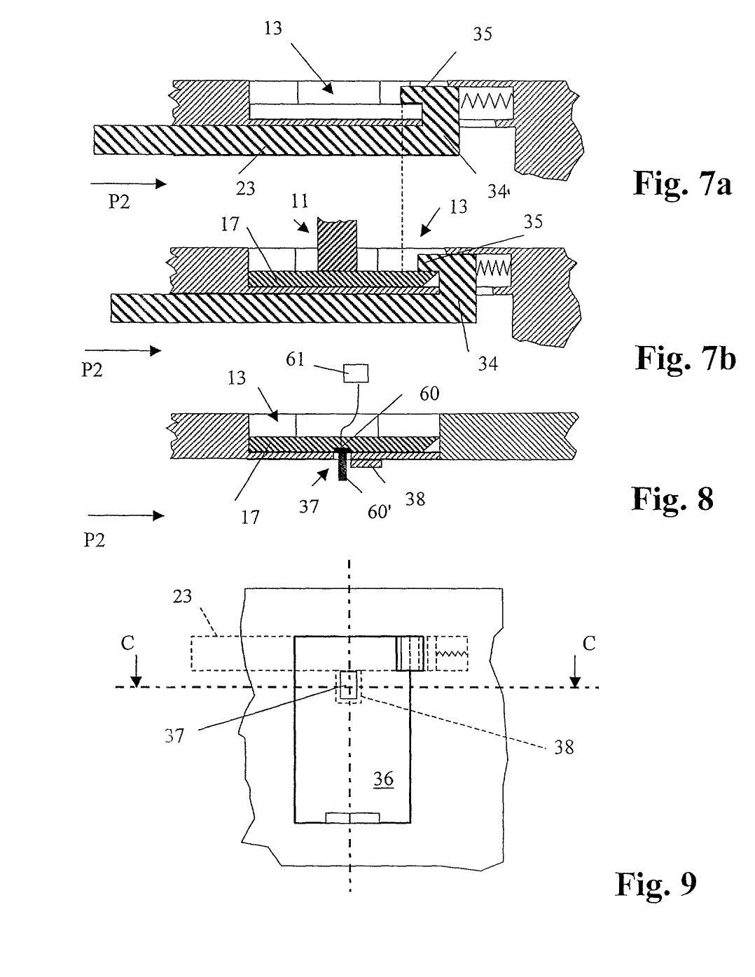

FIG. 7a shows a cross-section AA according to FIG. 4 in which there is no panel 17 inserted in the cavity 13. The stem 34 in FIGS. 7a and b is significantly wider than the stem 34 shown in the context of the example explained in FIGS. 4 through 6. If, as shown in FIG. 7b, a panel 17 whose dimensions match those of the panel 17 shown in FIGS. 4 through 6 is inserted in the cavity 13, the wider stem 34 will prevent the slider 23 from reaching its starting position as shown in FIG. 7a although in this example the leg 35 is also seated against the panel 17 and locks it in place.

FIG. 9, like FIG. 5, shows the rear view of a telephone 10 according to FIGS. 7a, b and 8. It can clearly be seen in this diagram that the base 36 is equipped with a window 37 that is closed by a part 38 connected to the slider 23 when there is no panel 17 inserted in the cavity 13. If as shown in FIG. 7b a panel 17 is inserted in the cavity 13, the slider 23 is moved in the direction of the arrow P2 due to the contact of the bevel 27″ with the leg 35 as already explained in the context of FIG. 4. In the example illustrated in FIGS. 7a through 9, this movement will also move the part 38 in the direction of the arrow P2, exposing the window 37. As the slider 23 cannot reach its starting position as shown in FIG. 7a when a panel 17 is inserted due to the wider stem 35, this means that the window 37 remains open. The latter is shown in FIG. 8, which shows a cross-section CC according to FIG. 9, although with a panel 17 inserted in the cavity 13. This open window 37 is used to establish the electrical contact between the telephone 10 and the panel 17. In FIG. 8 the panel 17 is equipped with a contact 60 for this purpose, which is then in contact with the contact 60′ extending through the open window 37. An advantage of this design is that the contact 60′ is automatically covered by the part 38 when the telephone 10 is removed from the holder 11.

However, if the telephone 10 in FIGS. 7a, 7b and 8 is removed from the holder 11, the contacts 60 are exposed. To provide shock protection for these contacts 60, too, these contacts 60 can be hidden by a cover, for example (not shown), that only exposes the contacts 60 after the telephone 10 is placed in the holder 11. It is even more advantageous, however, to connect the contacts 60 to a monitoring device 61 that then disconnects the exposed contacts 60 from their electrical supply when the telephone 10 is removed from the holder 11 or the physical contact between the contacts 60 and the contacts 60′ of the telephone 10 is broken.

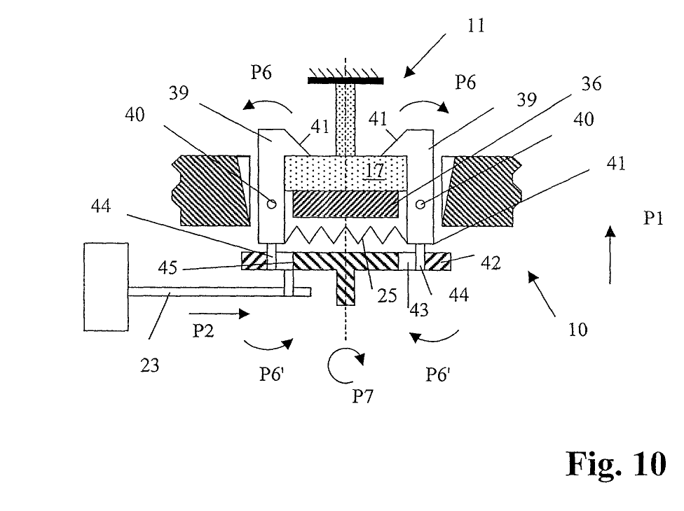

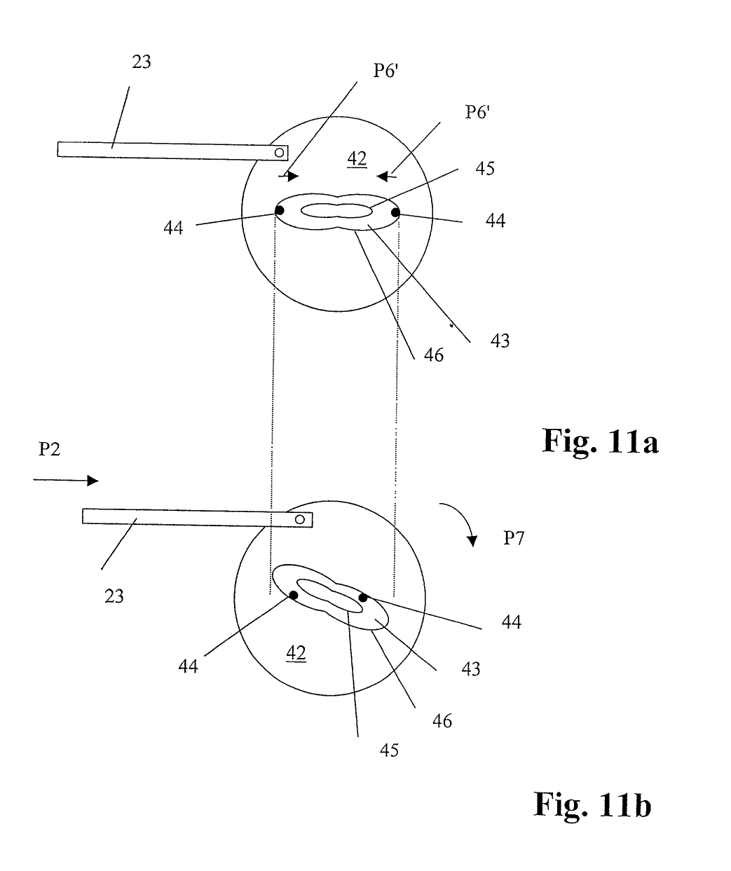

In the context of FIGS. 10, 11a and 11b there is a locking mechanism shown that is essentially formed by two locking hooks 39. It can clearly be seen in the diagram shown in FIG. 10 that when the telephone 10 is in the holder 11, the two locking hooks 39 hold the panel 17 belonging to the holder 11 in place when the panel 17 is placed on the base plate 36. As the locking hooks 39 are mounted on a shaft 40 and can rotate, they can be deflected in the direction of the arrow P6 and the bevels 41 of the locking hooks 39 come into physical contact with the panel 17 when the telephone 10 is pressed in the direction of the arrow P1 against the holder 11 to place the telephone 10 in the holder 11. If the movement in the direction of the arrow P1 is complete and the panel 17 lies against the base plate 36 as shown in FIG. 10, the locking hooks 39 are guided over the panel 17 by a movement in the opposite direction of the arrow P6 to fasten the telephone 10 and holder 11 together. The movement in the opposite direction of the arrow P6 is made possible in that the free ends 41 of the two locking hooks 39 are connected to each other by a (compression) spring 25 as shown in FIG. 10.

There is a rotatable disk 42 located under the base plate 36 to remove the telephone 10 from the holder 11. This disk 42 is equipped with a wide, figure-eight-shaped cutout 43 (see also FIGS. 11a and b) into which the pins 44 located on the free ends 41 of the locking hooks 39 extend. In addition, the disk 42 is connected to a slider 23 that can be moved in the direction of the arrow P2.

If there is no panel 17 between the locking hooks 39, the longest axis of the drawn out figure-eight-shaped cut-out 43 extends between the two pins 44 (FIG. 10 and FIG. 11a). Also, as the distance between the inner and outer edges 45, 46 of the cut-out 43 is greater than the diameter of the pin 44, the movement of the pins 44 in the direction of the arrow P6′ (FIGS. 10 and 11a) is not hindered by the inner edge 45 of the cut-out 43 when the telephone 10 is placed in the holder 11.

If the slider 23 is moved in the direction of the arrow P2 now to remove the telephone 10 from the holder 11, the disk 42 is rotated in the direction of the arrow P7 and then assumes the position shown in FIG. 1 lb. During this rotation (P7), the distance between the pins 44 is reduced and the locking hooks 39 (FIG. 10) are moved in the direction of the arrow P6 due to the contact of the pins 44 with the outer edge 46 of the cut-out 43. This movement of the locking hooks 39 triggered by the slider 23 makes it possible to remove the telephone 10 from the holder by moving it in the opposite direction of the arrow P1.

Due to the fact that the spring 25 was compressed at the same time as the locking hooks 39 were moved in the direction of the arrow P6, it is ensured that the slider 23 will return to the position illustrated in FIG. 11a due to the expansion of the spring 25 when no force acts on the slider 23 in the direction of the arrow P2.

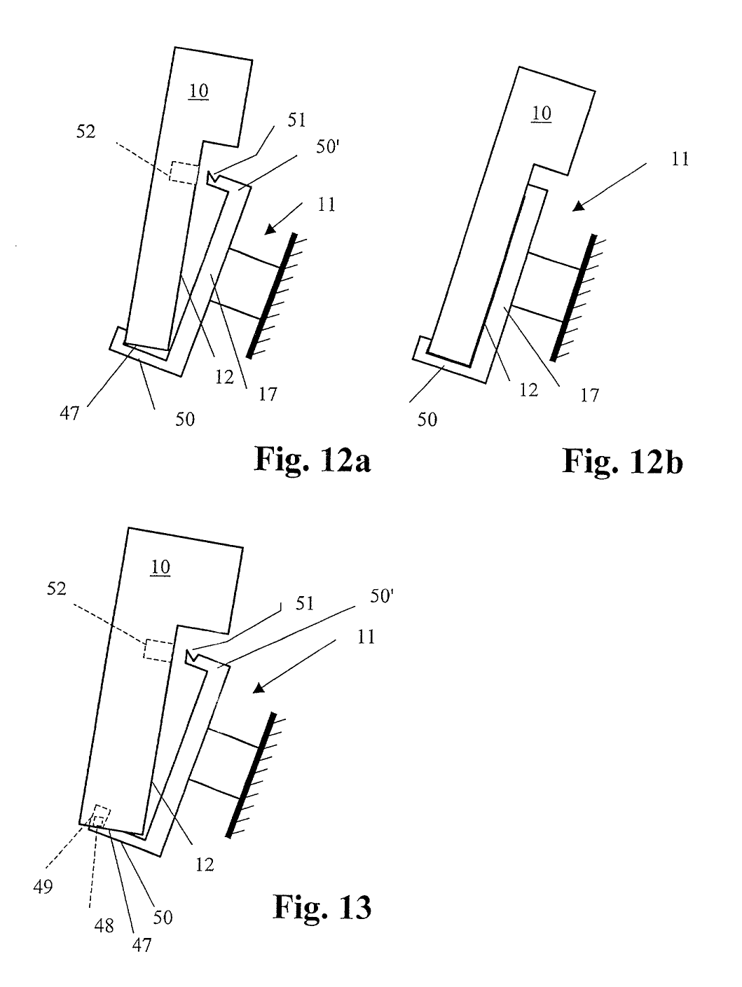

FIGS. 12a and 12b show a holder 11 for a telephone 10 in which the bottom surface 47 of the telephone 10 is enclosed by a hook-shaped flat section 50 connected to the panel 17. This design ensures that when the locking mechanism (not shown in FIGS. 12a and 12b) is released to separate the telephone 10 from the holder 11, the telephone 10 will still be supported by the holder 11. A similar purpose is also pursued in the design of the holder 11 shown in FIG. 13. In contrast to the design according to FIGS. 12a and 12b, the tab 48 on the flat section 50 engages a pocket 49 in the bottom surface 47 in this design.

In addition it can be seen in FIGS. 12a and 13 that the holder 11 or the panel 17 is equipped with another flat section 50′ having a hook 51. This flat section 50′ engages a recess 52 formed in the telephone 10 when the telephone is inserted in the holder 11 as shown in FIG. 12b. Even though the locking mechanism is not shown in FIGS. 12a, 12b and 13, it is still obvious that the hooks 51 found on the flat sections 50′ will function with the slider 23 already explained in sufficient detail in the context of the other figures.

Finally, we would like to point out that the term “telephone” 10 used in this application also includes handsets, regardless of whether or not the corresponding telephone has a wired or wireless connection to the other communication components.

1. Combination consisting of
a telephone 10 having a back 12 and at least one side surface 27 and
a holder 11 where the holder 14 holds the telephone 10 at least some of the time,
characterized in that
there is an operable device 23, 24 located inside the telephone 10 that can be operated from outside the telephone 10 that in one of its positions secures the telephone 10 on the holder 11 and in its other position allows the telephone 10 to be separated from holder 11.

2. Combination according to claim 1 characterized in that
there is a panel 17 and a cavity 13 complementary to the panel 17 and the panel 17 rests in the cavity 13 when the telephone 10 and holder 11 are joined.

3. Combination according to claim 2 characterized in that
the cavity 13 and the panel 17 each have a first edge 14, 20 and a second edge 16, 21 across from the first edge 14, 20,
there is a knuckle 15 formed on at least one of the first edges 14, 20 and
the operable device 23, 24 has a direct spatial and physical relationship to one of the two second edges 16, 21.

4. Combination according to claim 3 characterized in that
on the second edge 16, 21 that has a direct spatial and physical relationship to the operable device 23, 24 there is a latch 21a that, when the telephone 10 is joined to the holder 11, interacts with the operable device 23, 24 to lock the telephone 10 in place.

5. Combination according to claim 1 characterized in that
the holder 11 is essentially formed by a panel 17 and at least one flat section 50, 50′ connected to the panel 17 and running perpendicular to said panel 17, on at least one of the flat sections 50′ there is a latch 51 that interacts with the operable device 23, 24 when the telephone 10 is joined to the holder 11, and
the back 12 of the telephone 10 is seated against the panel 17 when the telephone 10 and holder 11 are joined.

6. Combination according to claim 5 characterized in that
there is at least one recess 52 formed on the back 12 of the telephone 10, one of the flat sections 50′ engages one of the recesses 52 when the telephone 10 is joined to the holder 11 and
at least one of the flat sections 50′ engaging a recess 52 is equipped with latches 51 that interact with the operable device 23, 24 when the telephone 10 is joined to the holder 11.

7. Combination according to one of claims 1 through 6 characterized in that
there are electrical contacts 60, 60′ formed on the holder 11 and on the telephone 10 that are complementary to each other and are in physical contact with each other when the telephone 10 is joined to the holder 11.

8. Combination according to claim 7 when the combination refers to one of claims 2 through 4, characterized in that
the contacts 60′ formed on the telephone 10 are covered by the operable device 23, 24, 38 when the telephone 10 is separated from the holder 11 and are only uncovered by the operable device 23, 24, 38 when it is moved by the latches 27″ when the telephone 10 is joined to the holder 11.

9. Combination according to one of claims 1 through 8 characterized in that
the operable device 23, 24 is a slider 24 connected to a handle 24.
